(19) United States
(12) Patent Application Publication
(10) Pub. No.: US 2011/0019559 A1
(43) Pub. Date: Jan. 27, 2011

(54) METHODS AND APPARATUS FOR STABILIZING FORWARD LINK MIMO RATE PREDICTION

(75) Inventors: Dhananjay A. Gore, San Diego, CA (US); Gwendolyn D. Barriac, San Diego, CA (US); Edward Harris Teague, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/509,776

(22) Filed: Jul. 27, 2009

(51) Int. Cl. H04L 12/26; H04L 27/28

(52) U.S. Cl. 370/252; 375/260

(57) ABSTRACT

A method for stabilizing forward link multiple-input and multiple-output (MIMO) rate prediction is described. The forward link channel quality is measured. Instantaneous channel quality estimates are determined for each instantaneous rank. Each instantaneous channel quality estimate provides an instantaneous rate estimate for the instantaneous rank. Rank defines the number of forward link transmission streams and rate defines the total capacity of the forward link for each rank. The instantaneous rates are filtered to determine an average rate per rank. A maximum rate is selected as the maximum over the determined average rate per rank. The instantaneous rank corresponding to the maximum rate is selected as the optimal rank. The instantaneous rate corresponding to the optimal rank is selected as the optimal rate. The optimal rank and optimal rate are then sent to an access point.

### TECHNICAL FIELD

The present disclosure relates generally to communication systems. More specifically, the present disclosure relates to methods and apparatus for stabilizing forward link MIMO rate prediction while reporting instantaneous channel measurements to a base station.

### BACKGROUND

Wireless communication systems are widely deployed to provide various types of communication content such as voice, video, data, and so on. These systems may be multiple-access systems capable of supporting simultaneous communication of multiple terminals with one or more base stations.

As used herein, the term “access terminal” refers to an electronic device that may be used for voice and/or data communication over a wireless communication network. Examples of access terminals include cellular phones, personal digital assistants (PDAs), handheld devices, wireless modems, laptop computers, personal computers, etc. An access terminal may alternatively be referred to as a mobile station, a mobile terminal, a subscriber station, a remote station, a user terminal, a terminal, a subscriber unit, user equipment, etc.

A wireless communication network may provide communication for a number of access terminals, each of which may be serviced by an access point. An access point may alternatively be referred to as a base station, a Node B, or some other terminology.

An access terminal may communicate with one or more access points via transmissions on the uplink and the downlink. The uplink (or reverse link) refers to the communication link from the access terminal to the access point, and the downlink (or forward link) refers to the communication link from the access point to the access terminal.

Communication between an access terminal in a wireless system (e.g., a multiple-access system) and an access point is effected through transmissions over a wireless link comprised of a forward link and a reverse link. Such communication link may be established via a single-input and single-output (SISO), multiple-input and single-output (MISO), or a multiple-input and multiple-output (MIMO) system. A MIMO system consists of transmitter(s) and receiver(s) equipped, respectively, with multiple (M_{T}) transmit antennas and multiple (M_{R}) receive antennas for data transmission. SISO and MISO systems are particular instances of a MIMO system. The MIMO system can provide improved performance (e.g., higher throughput, greater capacity, or improved reliability) if the additional dimensionalities created by the multiple transmit and receive antennas are utilized.

An access point may make judgments on channel statistics and use this information to determine future channel characteristics for the forward link. For example, the access point may determine the optimal number of streams to send to an access terminal over the forward link.

### BRIEF DESCRIPTION OF THE DRAWINGS

FIG. 1 shows a wireless communication system with an access terminal and an access point;

FIG. 2 shows a block diagram of an access terminal for use in the present systems and methods;

FIG. 3 is a wireless communication system that includes an access terminal and an access point;

FIG. 4 is a flow diagram illustrating a method for stabilizing forward link MIMO rate prediction while reporting instantaneous channel measurements to a base station;

FIG. 5 illustrates means-plus-function blocks corresponding to the method of FIG. 4;

FIG. 6 is a block diagram illustrating filtering to stabilize forward link MIMO rate prediction;

FIG. 7 is a block diagram illustrating a MIMO wireless communication system with an access point and an access terminal; and

FIG. 8 illustrates certain components that may be included within an access terminal.

### DETAILED DESCRIPTION

A method for stabilizing forward link multiple-input and multiple-output (MIMO) rate prediction is described. The forward link channel quality is measured. Instantaneous channel quality estimates are determined for each instantaneous rank. These provide an instantaneous rate estimate for each rank. Rank defines the number of forward link transmission streams, and rate defines the total capacity of the forward link for each rank. The instantaneous rates are filtered to determine an average rate per rank. A maximum rate is selected as a maximum over the determined average rate per rank. The instantaneous rank corresponding to the maximum rate is selected as the optimal rank. The instantaneous rate corresponding to the optimal rank is selected as the optimal rate. The optimal rank and optimal rate are sent to an access point.

The method may be performed by an access terminal. The optimal rank and optimal rate may be sent to the access point as part of a channel quality indicator (CQI). The instantaneous channel estimates for non-optimal ranks and non-optimal rates may not be sent to the access point. The maximum rate may be the maximum over the average rate per rank plus an additive constant per rank. Filtering instantaneous rates may determine the long term optimal number of layers for the forward link.

An access terminal configured for stabilizing forward link multiple-input and multiple-output (MIMO) rate prediction is described. The access terminal includes a processor. The access terminal also includes memory in electronic communication with the processor. The access terminal further includes instructions stored in the memory, the instructions being executable by the processor. The instructions are executable to measure the forward link channel quality. The instructions are also executable to determine instantaneous channel quality estimates for each instantaneous rank. These provide an instantaneous rate estimate for each rank. Rank defines the number of forward link transmission streams, and rate defines the total capacity of the forward link for each rank. The instructions are further executable to filter the instantaneous rates to determine an average rate per rank. The instructions are also executable to select a maximum rate as a maximum over the determined average rate per rank. The instructions are further executable to select the instantaneous rank corresponding to the maximum rate as the optimal rank. The instructions are also executable to select the instantaneous rate corresponding to the optimal rank as the optimal rate. The instructions are further executable to send the optimal rank and optimal rate to an access point.

An access terminal configured for stabilizing forward link multiple-input and multiple-output (MIMO) rate prediction is described. The access terminal includes means for measuring the forward link channel quality. The access terminal also includes means for determining instantaneous channel quality estimates for each instantaneous rank. These provide an instantaneous rate estimate for each rank. Rank defines the number of forward link transmission streams, and rate defines the total capacity of the forward link for each rank. The access terminal further includes means for filtering the instantaneous rates to determine an average rate per rank. The access terminal also includes means for selecting a maximum rate as a maximum over the determined average rate per rank. The access terminal further includes means for selecting the instantaneous rank corresponding to the maximum rate as the optimal rank. The access terminal also includes means for selecting the instantaneous rate corresponding to the optimal rank as the optimal rate. The access terminal further includes means for sending the optimal rank and optimal rate to an access point.

A computer-program product for an access terminal configured for stabilizing forward link multiple input and multiple output (MIMO) rate prediction is also described. The computer-program product includes a computer-readable medium having instructions thereon. The instructions include code for measuring the forward link channel quality. The instructions also include code for determining instantaneous channel quality estimates for each instantaneous rank. These provide an instantaneous rate estimate for each rank. Rank defines the number of forward link transmission streams and rate defines the total capacity of the forward link for each rank. The instructions further include code for filtering the instantaneous rates to determine an average rate per rank. The instructions also include code for selecting a maximum rate as a maximum over the determined average rate per rank. The instructions further include code for selecting the instantaneous rank corresponding to the maximum rate as the optimal rank. The instructions also include code for selecting the instantaneous rate corresponding to the optimal rank as the optimal rate. The instructions further include code for sending the optimal rank and optimal rate to an access point.

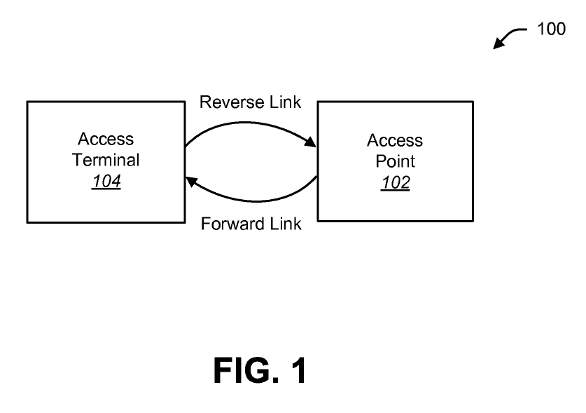

FIG. 1 shows a wireless communication system 100 with an access terminal 104 and an access point 102. An access point 102 is a station that communicates with one or more access terminals 104. An access point 102 may also be called, and may contain some or all of the functionality of, a base station, a Node B, an evolved Node B, etc. Each access point 102 provides communication coverage for a particular geographic area. The term “cell” can refer to an access point and/or its coverage area depending on the context in which the term is used.

An access terminal 104 may also be called, and may contain some or all of the functionality of, a terminal, a mobile station, a user equipment, a subscriber unit, a station, etc. An access terminal 104 may be a cellular phone, a personal digital assistant (PDA), a wireless device, a wireless modem, a handheld device, a laptop computer, etc. An access terminal 104 may communicate with zero, one, or multiple access points 102 on the forward link and/or reverse link at any given moment. The forward link refers to the communication link from the access points 102 to the access terminals 104, and the reverse link refers to the communication link from the access terminals 104 to the access points 102.

An access point 102 and an access terminal 104 may each utilize multiple receive and/or transmit antennas. The term “multiple-input and multiple-output” (MIMO) refers to the use of multiple antennas at both the transmitter and receiver to improve communication performance. At the transmitter, each portion of a data stream may be transmitted from a different antenna. At the receiver, the different portions of the data stream may be received by a different antenna and then combined. The terms “data stream” and “layer” are used interchangeably herein. The number of data streams for the forward link may be referred to as the “rank” of the forward link.

The access point 102 may send signals to an access terminal 104 over the forward link and receive signals from an access terminal 104 over the reverse link. The access point 102 may send a signal to the access terminal 104 that includes both MIMO and non-MIMO signaling. MIMO and non-MIMO signaling are often used together to fulfill different tasks. For example, in MIMO applications, MIMO signaling may be used for sending unicast user traffic and non-MIMO signaling (e.g., single-input and single-output (SISO)) may be used for sending broadcast control signals and preambles. The access point 102 may send a signal to the access terminal 104 that uses orthogonal frequency division multiple access (OFDMA) in combination with MIMO to achieve high data rates.

To maximize throughput on the forward link, the access point 102 may require channel quality information concerning the forward link. For example, the access point 102 may need the possible ranks that can be supported on the forward link. The access point 102 may also need the rate that can be supported on the forward link for each possible rank. The rate refers to the total capacity for the forward link that corresponds to a specific rank. Because only the access terminal 104 can measure the forward link channel quality, the access terminal 104 may feedback the measured channel quality information to the access point 102. The access point 102 may then make judgments on the channel statistics.

Feeding back channel quality information for all supported ranks (layers) for an air interface may overly burden the reverse link control channel by creating unnecessary overhead. To minimize this overhead, the access terminal 104 may determine the optimal number of streams for the forward link. The access terminal 104 may then send the channel quality information that corresponds to the optimal number of streams to the access point 102. It may be advantageous for the access terminal 104 to report instantaneous estimates of the channel quality to the access point 102 instead of reporting filtered estimates of the channel quality. Generally, estimates of the channel quality may be based on pilot measurements. Typically, these pilots are not continuous; instead they may be transmitted with some period. Channel quality estimates based on these pilots may be dependent on the time the pilot was transmitted. These pilot measurements may be referred to as instantaneous channel quality measurements. Instantaneous channel quality measurements may be used by the access point 102 for power controlling transmissions. The instantaneous channel quality measurements may be filtered to develop an ‘average’ estimate of the channel quality. The ‘average’ estimate of the channel quality may thus be referred to as a filtered estimate of the channel quality. Reporting instantaneous estimates of the channel quality may improve the power control for forward link transmissions.

If the access terminal 104 reports instantaneously optimal information concerning the rank (i.e. number of streams), the access point 102 may rapidly toggle the transmitted rank, thereby causing increased forward link assignment overhead. This toggling may be due to inaccuracies in channel estimation at the access terminal 104. A technique for robust rank selection may eliminate this toggling by allowing the access point 102 to receive instantaneous channel quality information while maintaining smooth transitions between the number of layers (rank) used by the access point 102 for the forward link.

In the technique for robust rank selection, the access terminal 104 may separately filter the capacity estimates for x number of streams, where x goes from 1 to the maximum number of streams supported by the air interface. The filtering may be implemented by the access terminal 104 (and not the access point 102) because the access terminal 104 has access to the relevant information, such as the channel capacity estimates for all possible ranks.

If the access point 102 were to perform the filtering, the filtering may be performed using less information. For example, if the instantaneously optimal number of layers at the access terminal 104 was toggling between x and x+1, then the access point 102 may receive alternating channel information for x layers and x+1 layers. Therefore, the filtered values at the access point 102 for the channel quality of x layers and x+1 layers may each be based on only half of the total information that the access terminal 104 has.

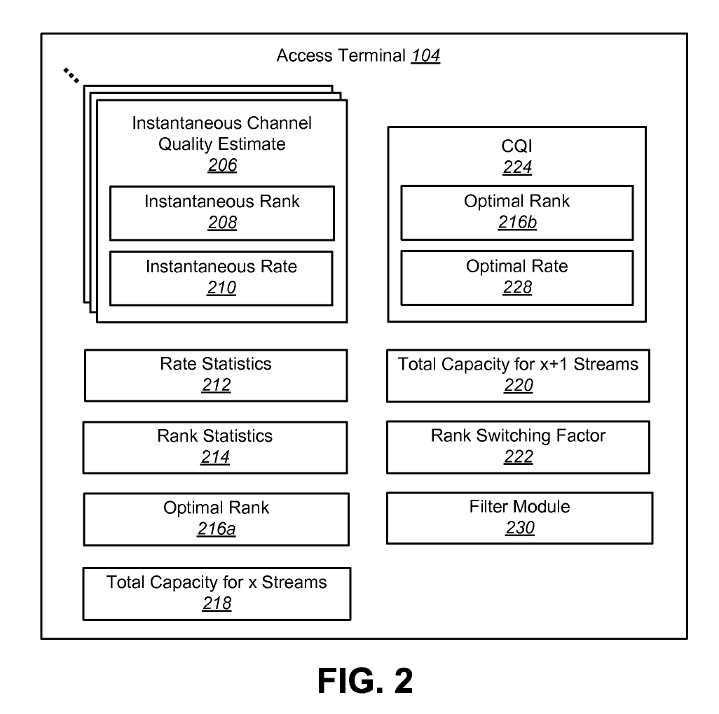

FIG. 2 shows a block diagram of an access terminal 104 for use in the present systems and methods. An access terminal 104 may include one or more instantaneous channel quality estimates 206. The access terminal 104 may measure the received forward link channel to determine the one or more instantaneous channel quality estimates 206. For example, the access terminal 104 may make instantaneous channel quality estimates 206 for each of the various allowable streams supported by the air interface. Thus, the access terminal 104 may include an instantaneous channel quality estimate 206 for each of one stream (rank 1) through the maximum number of streams supported by the air interface. Each instantaneous channel quality estimate 206 may include the instantaneous rank 208 and the corresponding instantaneous rate 210.

The access terminal 104 may include rate statistics 212 and rank statistics 214. The access terminal 104 may thus be capable of determining the long term optimal number of layers (rank) and the corresponding rates, rather than just the instantaneous optimal number of layers. The underlying rank structure of the forward link channel may change with slower dynamics than the actual channel fade. Hence, filtering instantaneous channel quality estimates 206 before determining the optimal rank may be more desirable. The access terminal 104 may use a filter module 230 to filter the instantaneous channel quality estimates 206 and determine the optimal rank 216.

The access terminal 104 may toggle between an optimal rank 216 corresponding to x streams and an optimal rank 216 corresponding to x+1 streams. An optimal rank 216 of x may have a corresponding total capacity for x streams 218 and an optimal rank 216 of x+1 may have a corresponding total capacity for x+1 streams 220. If the total capacity for x streams 218 and the total capacity for x+1 streams 220 are very near each other, the access terminal 104 may rapidly switch between an optimal rank 216 of x and an optimal rank 216 of x+1. To avoid the increased forward link overhead for such switching, the access terminal 104 may include a rank switching factor 222. For example, the access terminal 104 may include a value of delta for the rank switching factor 222. The rank switching factor 222 is a value that defines a buffer for the selected optimal rank 216, such that small changes to the total capacity for the optimal rank 216 do not cause the optimal rank 216 to rapidly toggle between two values.

The rank switching factor 222 may be a configurable value for the access terminal 104. For example, the rank switching factor 222 may be a predetermined set of parameters that can be configured during boot-up. As another example, the rank switching factor 222 may be indicated by the access point 102 through predetermined over-the-air messages. The access terminal 104 may include a unique rank switching factor 222 for each allowable rank of the air interface. Alternatively, the access terminal 104 may include one rank switching factor 222 for all allowable ranks. The access terminal 104 may compare the total capacity for x streams 218 to the total capacity for x+1 streams 220 and may select x+1 as the optimal rank 216 only when the total capacity for x+1 streams 220 is greater than the total capacity for x streams 218 plus the rank switching factor 222. As an example, this may provide benefits when the toggling between ranks is due to an environment with poor rank where there may be a bias towards a certain rank due to a bias in the capacity estimates.

The access terminal 104 may include a channel quality indicator (CQI) 224. The access terminal 104 may prepare the CQI 224 for the access point 102. The CQI 224 may include the optimal rank 216 selected by the access terminal 104. The CQI 224 may also include the optimal rate 228, which is the instantaneous rate 210 associated with the optimal rank 216. The access terminal 104 may send the CQI 224 to the access point 102. The access terminal 104 may also include a filter module 230. The filter module 230 may filter the capacity estimates for each rank. The access terminal 104 may use the filter module 230 to determine the number of streams which gives the highest filtered capacity for the forward link. Thus, the access terminal 104 may use the filter module 230 to determine the optimal rank 216 for the forward link that produces the maximum rate.

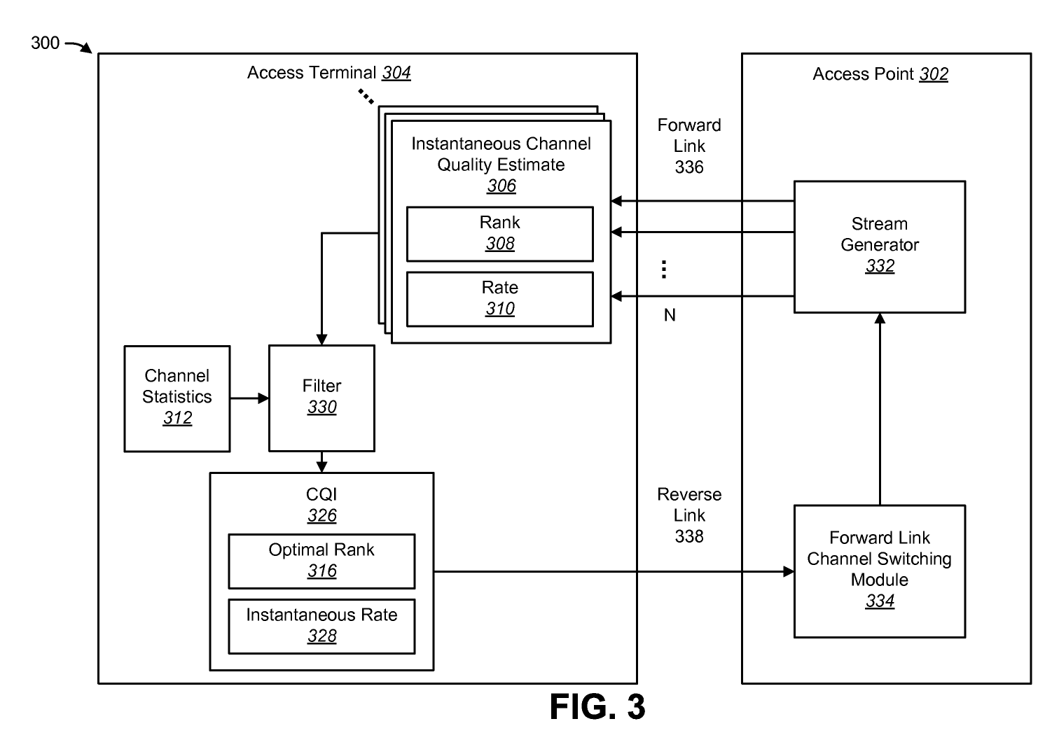

FIG. 3 is a wireless communication system 300 that includes an access terminal 304 and an access point 302. The access terminal 304 may receive one or more streams of data from the access point 302 over the forward link 336. The number of streams N received by the access terminal 304 may be referred to as the instantaneous rank of the forward link 336. The access terminal 304 may make measurements on the forward link 336 channel. For example, the access terminal 304 may measure the instantaneous rank and the corresponding instantaneous rate for the forward link 336. The access terminal 304 may then make an instantaneous channel quality estimate 306 for each of the ranks 308 allowable for the air interface on the forward link 336. Each instantaneous channel quality estimate 306 may include the rank 308 and the rate 310 estimated for the forward link channel.

The access terminal 304 may include a filter 330. The access terminal 304 may filter the instantaneous channel quality estimates 306 along with other channel statistics 312 to determine the number of streams (optimal rank 316) that will give the highest capacity for the forward link 336. The filtering may prevent toggling between different numbers of layers, while still sending instantaneous channel quality information to the access point 302.

It may be beneficial to bias the decision of the filtering in favor of single-input single-output (SISO). For example, in poor rank environments where the actual supported channel capacity for MIMO (rank>1) and single-input multiple-output (SIMO) (rank=1) are comparable, MIMO may be determined to be optimal due to bias in the MIMO channel estimates. Also, even in environments with good rank structure, it may be beneficial to select SISO over MIMO when the signal to interference plus noise ratio (SINR) is low enough.

The access terminal 304 may send both the optimal rank 316 and the corresponding capacity (instantaneous rate 328) to the access point 302 as part of a CQI 326.

The access point 302 may receive the CQI 326 from the access terminal 304. The access point 302 may receive the CQI 326 over the reverse link 338. Based on the received CQI 326, a forward link channel switching module 334 on the access point 302 may select the number of layers to transmit on the forward link 336 that is optimal. For example, the forward link channel switching module 334 may select the number of layers to transmit on the forward link 336 that produces the highest total capacity. The access point 302 may then transmit the optimal number of layers on the forward link 302 using a stream generator 332.

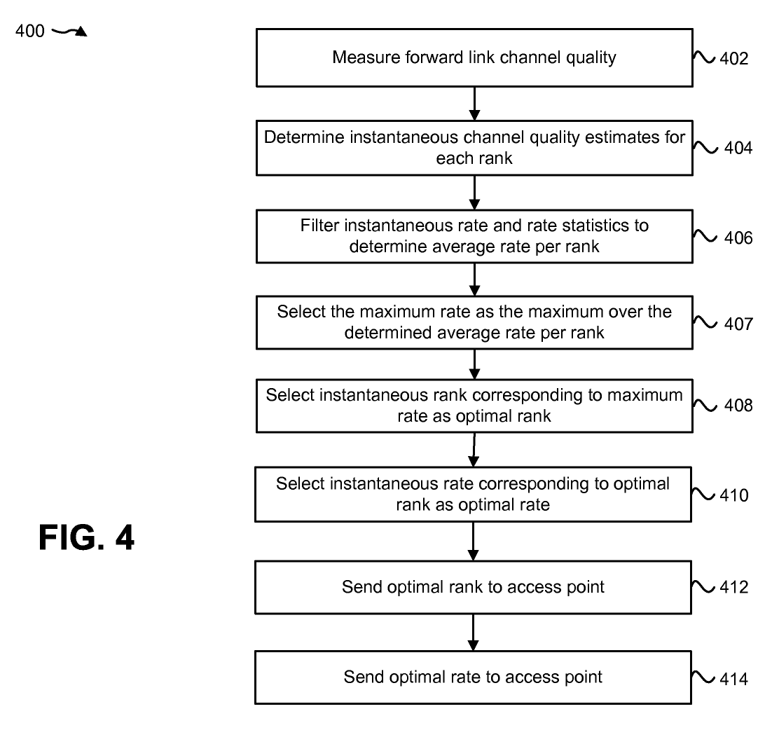

FIG. 4 is a flow diagram illustrating a method 400 for stabilizing forward link MIMO rate prediction while reporting instantaneous channel measurements to a base station. An access terminal 104 may measure 402 the forward link channel quality. The access terminal 104 may determine 404 instantaneous channel quality estimates 206 including an instantaneous rate 210 for each rank 208. The instantaneous channel quality estimates 206 may provide an instantaneous rate 210 estimate for each instantaneous rank 208. The access terminal 104 may next filter 406 the instantaneous rate 210 and rate statistics 212 to determine the average rate per rank.

The access terminal 104 may filter 406 the instantaneous rate 210 and rate statistics 212 in several different ways. For example, filtering may be achieved through use of an infinite impulse response (IIR) filter or a finite impulse response (FIR) filter. The time period for the filter may be controlled through filter tuning parameters. In the case of an FIR filter, the time period may be controlled through the filter length and the filter coefficients. In a degenerate case, the filter length (for an FIR filter) may be made equal to one. In this case, the average rate and instantaneous rates for the filter are one and the same. This can be achieved for an IIR filter through appropriate modification of the filter tuning parameter.

The access terminal 104 may then select 407 the maximum rate as the maximum over the determined average rate per rank. In one configuration, the maximum rate may be the maximum over the determined average rate per rank plus an additive constant per rank. Once the access terminal 104 has determined the maximum rate, the access terminal 104 may select 408 the instantaneous rank 208, which corresponds to the maximum rate, as the optimal rank 216. The access terminal 104 may then select 410 the instantaneous rate 210, which corresponds to the optimal rank 216, as the optimal rate 228. The access terminal 104 may then send 412 the optimal rank 216 to the access point 102. The access terminal 104 may also send 414 the optimal rate 228 to the access point 102. The access terminal 104 may send both the optimal rank 216 and the optimal rate 228 as part of a CQI 224.

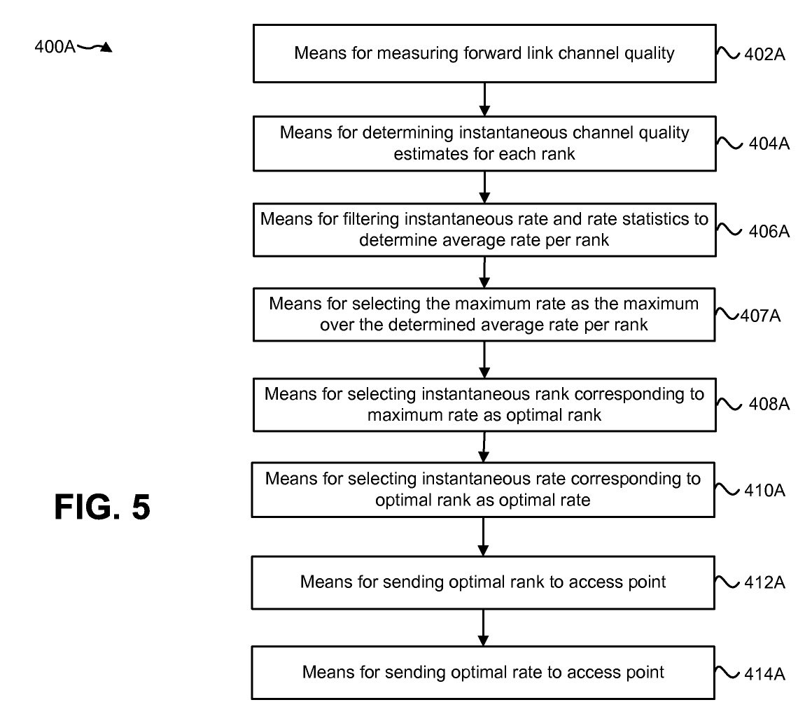

The method 400 of FIG. 4 described above may be performed by various hardware and/or software component(s) and/or module(s) corresponding to the means-plus-function blocks 400A illustrated in FIG. 5. In other words, blocks 402 through 414 illustrated in FIG. 4 correspond to means-plus-function blocks 402A through 414A illustrated in FIG. 5.

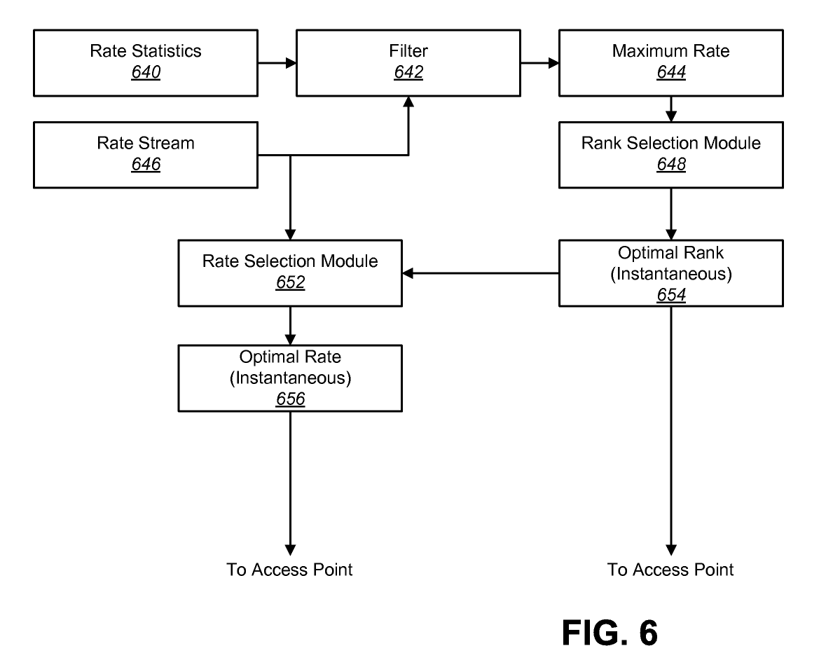

FIG. 6 is a block diagram illustrating filtering to stabilize forward link MIMO rate prediction. A filter 642 may receive a continuous rate stream 646. The rate stream 646 may include the rates for each instantaneous channel quality estimate 206. The filter 642 may also receive rate statistics 640. The rate statistics 640 may include prior rate information concerning the forward link.

The filter 642 may output the maximum rate 644. A rank selection module 648 may receive the maximum rate 644. The rank selection module 648 may select the instantaneous rank 208 that corresponds to the maximum rate 644 as the optimal rank 654. A rate selection module 652 may receive the rate stream 646 along with the optimal rank 654. The rate selection module 652 may select the instantaneous rate 210 that corresponds to the optimal rank 654 as the optimal rate 656. The instantaneous rate 210 that corresponds to the optimal rank 654 may be selected from the rate stream 646. The optimal rate 656 and the optimal rank 654 may then be sent to the access point 102.

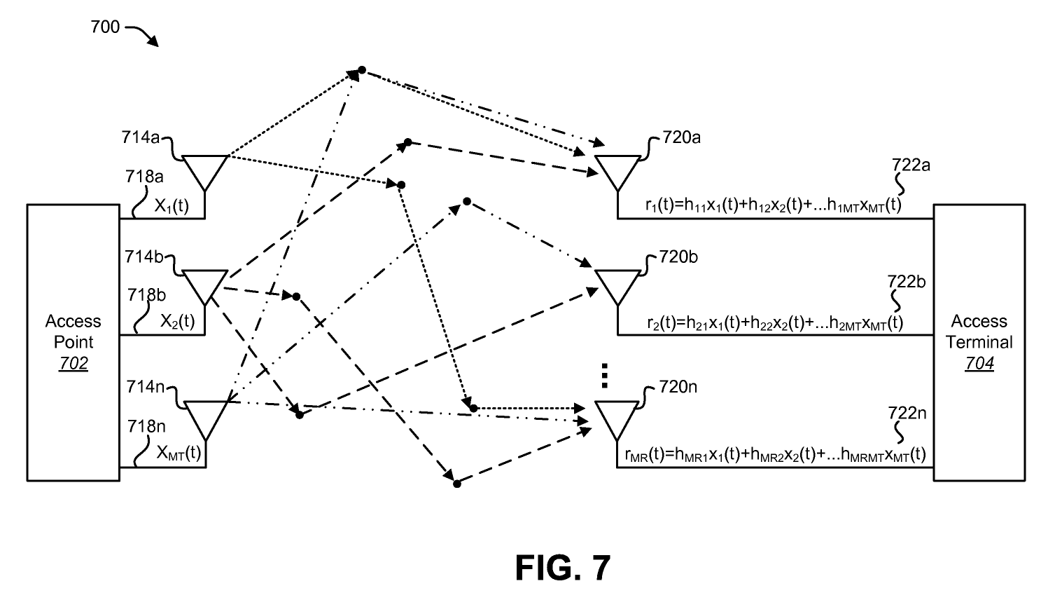

FIG. 7 is a block diagram illustrating a MIMO wireless communication system 700 with an access point 702 and an access terminal 704. The access point 702 may include a data stream to be transmitted to the access terminal 704 over the forward link. The access point 702 may separate the data stream into multiple transmission signals 718a-n for transmission by MT antennas 714a-n. For example, a data stream x may be separated into x₁(t), x₂(t), . . . ,x_{M}_{_{T}}(t). The access point 702 may then transmit each of the separate signals 718a-n in parallel using the multiple transmit antennas 714a-n. Each of the signals transmitted may be referred to as a stream transmitted from the access point 702.

The access terminal 704 may receive the transmission signals 718a-n using M_{R} receive antennas 720a-n. The transmission signals 718a-n may combine between transmission by the access point 702 and reception by the access terminal 704. Because each transmission signal 718a-n may travel from a transmit antenna 714a-n to a receive antenna 720a-n over a different path, each of the independent channel streams is received with an estimated individual channel weight h. Thus, the received signal 722a by the first antenna 720a may be represented by r₁(t)=h₁₁x₁(t)+h₁₂x₂(t)+ . . . h_{1M}_{_{T}}x_{M}_{_{T}}(t), the received signal 722b by the second antenna 720b may be represented by r₂(t)=h₂₁x₁(t)+h₂₂x₂(t)+ . . . h_{2M}_{_{T}}x_{M}_{_{T}}(t) and the received signal 722n by antenna M_{R} 720n may be represented by r_{M}_{_{R}}(t)=h_{M}_{_{R}}₁x₁(t)+h_{M}_{_{R}}₂x₂(t)+ . . . h_{M}_{_{R}}_{M}_{_{T}}x_{M}_{_{T}}(t). To recover x, the access terminal 704 may construct a channel matrix H using the estimated individual channel weights h. The access terminal 704 may solve for the transmitted vector x by multiplying the received vector r with the inverse of H. The access terminal 704 may thus recover the original data stream that was transmitted.

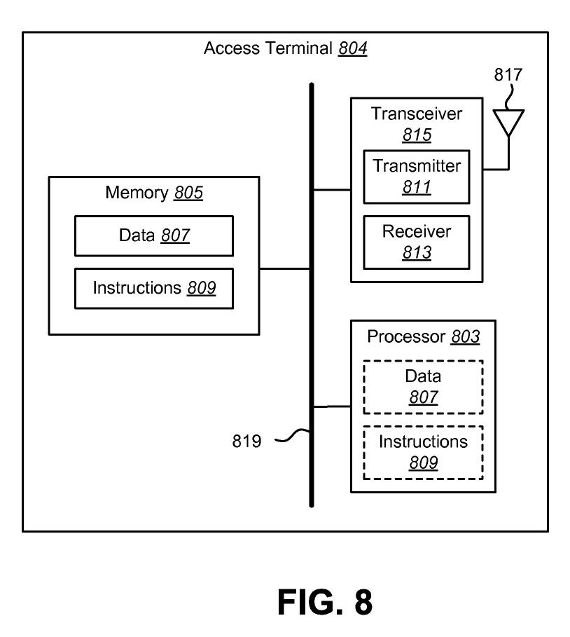

FIG. 8 illustrates certain components that may be included within an access terminal 804. The access terminal 804 includes a processor 803. The processor 803 may be a general purpose single- or multi-chip microprocessor (e.g., an ARM), a special purpose microprocessor (e.g., a digital signal processor (DSP)), a microcontroller, a programmable gate array, etc. The processor 803 may be referred to as a central processing unit (CPU). Although just a single processor 803 is shown in the access terminal 804 of FIG. 8, in an alternative configuration, a combination of processors (e.g., an ARM and DSP) could be used.

The access terminal 804 also includes memory 805. The memory 805 may be any electronic component capable of storing electronic information. The memory 805 may be embodied as random access memory (RAM), read only memory (ROM), magnetic disk storage media, optical storage media, flash memory devices in RAM, on-board memory included with the processor, EPROM memory, EEPROM memory, registers, and so forth, including combinations thereof.

Data 807 and instructions 809 may be stored in the memory 805. The instructions 809 may be executable by the processor 803 to implement the methods disclosed herein. Executing the instructions 809 may involve the use of the data 807 that is stored in the memory 805.

The access terminal 804 may also include a transmitter 811 and a receiver 813 to allow transmission and reception of signals between the access terminal 804 and a remote location. The transmitter 811 and receiver 813 may be collectively referred to as a transceiver 815. An antenna 817 may be electrically coupled to the transceiver 815. The access terminal 804 may also include (not shown) multiple transmitters, multiple receivers, multiple transceivers and/or multiple antenna.

The various components of the access terminal 804 may be coupled together by one or more buses, which may include a power bus, a control signal bus, a status signal bus, a data bus, etc. For the sake of clarity, the various buses are illustrated in FIG. 8 as a bus system 819.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The term “computer-readable medium” refers to any available tangible medium that can be accessed by a computer. By way of example, and not limitation, a computer-readable medium may comprise RAM, ROM, EEPROM, CD-ROM or other optical disk storage, magnetic disk storage or other magnetic storage devices, or any other tangible medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 4, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for stabilizing forward link multiple-input and multiple-output (MIMO) rate prediction, the method comprising:
measuring the forward link channel quality;
determining an instantaneous channel quality estimate for each instantaneous rank, wherein an instantaneous channel quality estimate provides an instantaneous rate estimate for the instantaneous rank, and wherein rank defines the number of forward link transmission streams and rate defines the total capacity of the forward link for each rank;
filtering the instantaneous rates to determine an average rate per rank;
selecting a maximum rate as a maximum over the determined average rate per rank;
selecting the instantaneous rank corresponding to the maximum rate as the optimal rank;
selecting the instantaneous rate corresponding to the optimal rank as the optimal rate; and
sending the optimal rank and optimal rate to an access point.

2. The method of claim 1, wherein the method is performed by an access terminal.

3. The method of claim 1, wherein the optimal rank and optimal rate are sent to the access point as part of a channel quality indicator (CQI).

4. The method of claim 1, wherein the instantaneous channel estimates for non-optimal ranks and non-optimal rates are not sent to the access point.

5. The method of claim 1, wherein the maximum rate is the maximum over the average rate per rank plus an additive constant per rank.

6. The method of claim 1, wherein filtering instantaneous rates determines the long term optimal number of layers for the forward link.

7. An access terminal configured for stabilizing forward link multiple-input and multiple-output (MIMO) rate prediction, comprising:
a processor;
memory in electronic communication with the processor;
instructions stored in the memory, the instructions being executable by the processor to:
measure the forward link channel quality;
determine instantaneous channel quality estimates for each instantaneous rank, wherein an instantaneous channel quality estimate provides an instantaneous rate estimate for the instantaneous rank, and wherein rank defines the number of forward link transmission streams and rate defines the total capacity of the forward link for each rank;
filter the instantaneous rates to determine an average rate per rank;
select a maximum rate as a maximum over the determined average rate per rank;
select the instantaneous rank corresponding to the maximum rate as the optimal rank;
select the instantaneous rate corresponding to the optimal rank as the optimal rate; and
send the optimal rank and optimal rate to an access point.

8. The access terminal of claim 7, wherein the optimal rank and optimal rate are sent to the access point as part of a channel quality indicator (CQI).

9. The access terminal of claim 7, wherein the instantaneous channel estimates for non-optimal ranks and non-optimal rates are not sent to the access point.

10. The access terminal of claim 7, wherein the maximum rate is the maximum over the average rate per rank plus an additive constant per rank.

11. The access terminal of claim 7, wherein filtering instantaneous rates determines the long term optimal number of layers for the forward link.

12. An access terminal configured for stabilizing forward link multiple-input and multiple-output (MIMO) rate prediction, comprising:
means for measuring the forward link channel quality;
means for determining an instantaneous channel quality estimate for each instantaneous rank, wherein an instantaneous channel quality estimate provides an instantaneous rate estimate for the instantaneous rank, and wherein rank defines the number of forward link transmission streams and rate defines the total capacity of the forward link for each rank;
means for filtering the instantaneous rates to determine an average rate per rank;
means for selecting a maximum rate as a maximum over the determined average rate per rank;
means for selecting the instantaneous rank corresponding to the maximum rate as the optimal rank;
means for selecting the instantaneous rate corresponding to the optimal rank as the optimal rate; and
means for sending the optimal rank and optimal rate to an access point.

13. The access terminal of claim 12, wherein the optimal rank and optimal rate are sent to the access point as part of a channel quality indicator (CQI).

14. The access terminal of claim 12, wherein the maximum rate is the maximum over the average rate per rank plus an additive constant per rank.

15. The access terminal of claim 12, wherein filtering instantaneous rates determines the long term optimal number of layers for the forward link.

16. A computer-program product for an access terminal configured for stabilizing forward link multiple input and multiple output (MIMO) rate prediction, the computer-program product comprising a computer-readable medium having instructions thereon, the instructions comprising:
code for measuring the forward link channel quality;
code for determining an instantaneous channel quality estimate for each instantaneous rank, wherein an instantaneous channel quality estimate provides an instantaneous rate estimate for the instantaneous rank, and wherein rank defines the number of forward link transmission streams and rate defines the total capacity of the forward link for each rank;
code for filtering the instantaneous rates to determine an average rate per rank;
code for selecting a maximum rate as a maximum over the determined average rate per rank;
code for selecting the instantaneous rank corresponding to the maximum rate as the optimal rank;
code for selecting the instantaneous rate corresponding to the optimal rank as the optimal rate; and
code for sending the optimal rank and optimal rate to an access point.

17. The computer-program product of claim 16, wherein the optimal rank and optimal rate are sent to the access point as part of a channel quality indicator (CQI).

18. The computer-program product of claim 16, wherein the maximum rate is the maximum over the average rate per rank plus an additive constant per rank.

19. The computer-program product of claim 16, wherein filtering instantaneous rates determines the long term optimal number of layers for the forward link.
